(19) United States
(12) Patent Application Publication
(10) Pub. No.: US 2010/0089617 A1
(43) Pub. Date: Apr. 15, 2010

(54) HIGH VOLTAGE SHIELD

(75) Inventors: Ralf Hartings, Ludvika (SE); Uno Gäfvert, Vasteras (SE); Kerstin M. Ekeroth Reijm, Borlange (SE); Thomas Eriksson, Ludvika (SE); Tommy L. Larsson, Ludvika (SE)

Correspondence Address: VENABLE LLP, P.O. BOX 34385, WASHINGTON, DC, 20043-9998, US

(73) Assignee: ABB RESEARCH LTD.

(21) Appl. No.: 12/439,564

(22) PCT Filed: Aug. 31, 2007
(86) PCT No.: PCT/SE2007/050602

§ 371 Date: Dec. 7, 2009

(30) Foreign Application Priority Data
Aug. 31, 2006 (SE) 0601788-3

(51) Int. Cl. H01B 17/26; H01B 17/44

(52) U.S. Cl. 174/142; 174/140 CR

(57) ABSTRACT

A high voltage corona shield including a body portion including a polymer material.

### FIELD OF INVENTION

The present invention relates generally to high voltage corona shields and more particularly to a high voltage corona shield having an improved internal design. The invention also relates to a high voltage bushing and a high voltage device comprising such high voltage corona shield.

### BACKGROUND

It is known that electrical equipment and devices, such as high voltage transformers, are usually equipped with bushings, which are suitable to carry current at high potential through a grounded barrier, e.g. a transformer tank or a wall.

Conventional bushings are constituted by an insulator made of ceramic or composite material, which is provided with sheds and is generally hollow. The voltage grading can be obtained with or without a condenser body through which the electrical conductor passes.

An example of a bushing adapted for use with a high voltage DC transformer will now be described with reference to FIG. 1 showing the overall structure of the bushing, referenced 1, and FIG. 2 showing a high voltage transformer 100 provided with bushings of FIG. 1, which are electrically connected to a transformer housing 102.

A high voltage conductor (not shown) runs through the center of a hollow bushing insulator 2 that forms a housing around the high voltage conductor. A flange 4 is provided to connect the housing of the bushing to ground through a tank assembly housing or a wall. A ground potential grading shield (not shown) may be mounted to the flange.

The bottom end portion of the high voltage conductor forms a bottom contact 6, which is arranged to be connected to the internal components of the transformer. An upper outer terminal (not shown) is provided at the end of the bushing opposite the bottom contact end in order to electrically connect the transformer device to external sources.

A corona shield 10 is arranged radially outside of the outer terminal 8. This corona shield is provided to eliminate or at least minimize corona appearing close to the outer terminal. The existence of corona—partial discharge in air—generates ozone, which is highly corrosive. The combination of corona, moisture, and time will cause rapid decay of the equipment. Also, corona may cause sparking and radio interference. By providing an electrically conductive corona shield radially outside of the outer terminal, the risk of corona appearing is decreased.

A high voltage device 100, such as a high voltage transformer, provided with a plurality of bushings 1 is shown in FIG. 2.

It is recognized that corona shields, particularly in very high voltage applications, such as 600 or 800 kV, are very heavy when they are made of a metal material, as is conventional. Furthermore, the complexity of manufacturing increases with the total size of the corona shield, which can be one meter in diameter or more.

### SUMMARY OF THE INVENTION

An object of the present invention is to provide a high voltage corona shield which has less weight than prior art corona shields and which is easier to manufacture. Further objects are to provide a bushing and a high voltage device with a high voltage corona shield.

The invention is based on the realization that corona shields for high voltage applications can be manufactured from conductive or non conductive polymer materials, resulting in the corona shield being less heavy than comparable corona shields made of metal material throughout.

According to a first aspect of invention a high voltage corona shield for use with a high voltage device is provided, the high voltage corona shield comprising a body arranged to be electrically connected to the high voltage device, characterized in that the body comprises a polymer material.

According to further aspects of the invention, a high voltage bushing as defined in appended claim 7 and a high voltage device as defined in appended claim 8 are provided.

With the inventive arrangement, several advantages are obtained. Since the weight of the corona shield is reduced, it is well suited for applications wherein the weight of the corona shield is of importance, such as in high voltage devices subjected to earthquake demands. Also, by providing the corona shield in a polymer material, manufacturing thereof is facilitated, possibly resulting in lower cost. Since the corona shield is made of non-corroding polymer, corrosion of the corona shield is avoided. The use of a polymer material also gives increased flexibility as regards the external design or shape of the corona shield.

In a preferred embodiment, the body of the high voltage corona shield is made of an electrically non-conductive material, reducing the appearance of eddy currents in the material of the corona shield.

In a preferred embodiment, the electrically conductive layer on the high voltage corona shield is an electrically conductive paint, which is easy to apply in a manufacturing process. The electrically conductive paint is preferably a paint comprising silver, which has excellent electrical and anti-corrosive properties.

Further embodiments are defined in the dependent claims.

### BRIEF DESCRIPTION OF DRAWINGS

The invention is now described, by way of example, with reference to the accompanying drawings, in which:

FIG. 1 is an overall view of a high voltage bushing provided with a corona shield;

FIG. 2 shows a high voltage device, such as a transformer, provided with corona shield bushings; and

FIG. 3a is a sectional view of a first embodiment of a corona shield according to the invention;

FIG. 3b is a sectional view of an alternative first embodiment of a corona shield according to the invention;

FIG. 4 is a sectional view of a second embodiment of a corona shield according to the invention; and

FIG. 5 is a sectional view of a third embodiment of a corona shield according to the invention.

### DETAILED DESCRIPTION OF A PREFERRED EMBODIMENT OF THE INVENTION

In the following a detailed description of a preferred embodiment of the present invention will be given. In this description, the term “high voltage” will be used for voltages of 50 kV and higher. Today, the upper limit in commercial high voltage devices is 800 kV but even higher voltages, such as 1000 kV or more, are already built or envisaged in the near future.

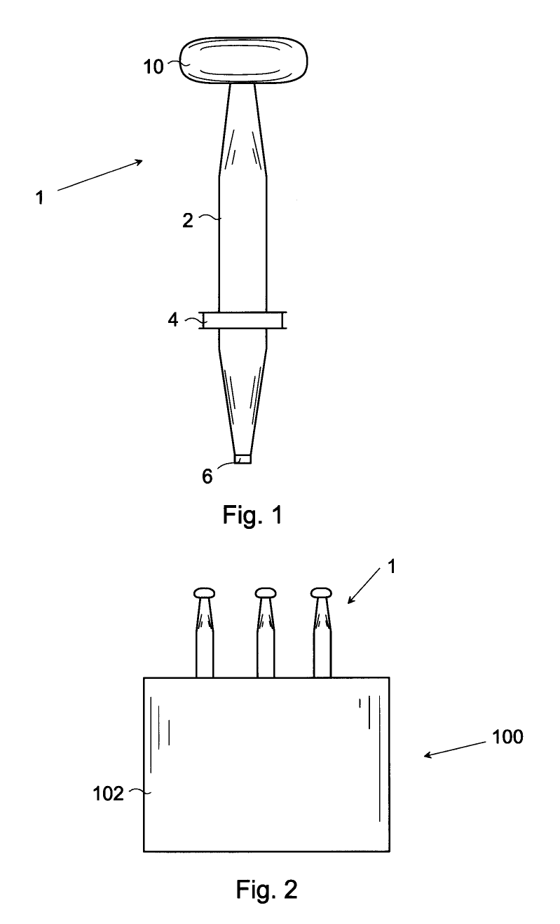

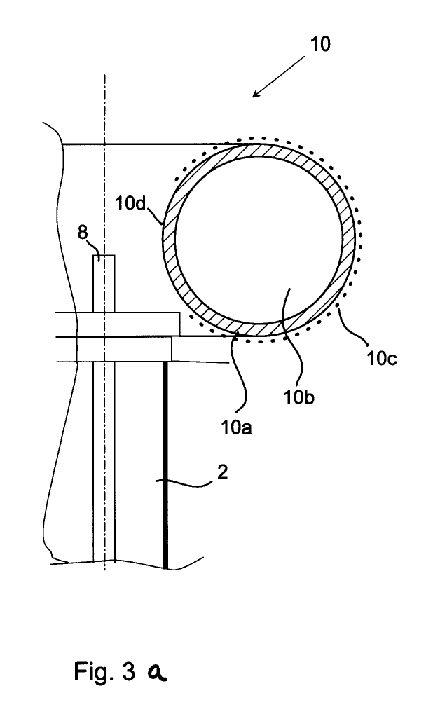

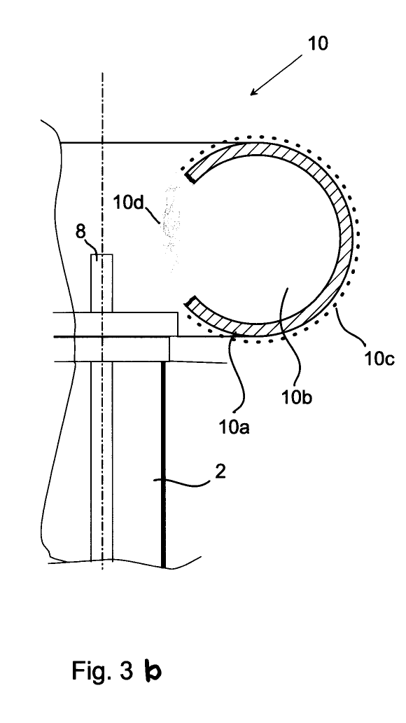

The present invention is applicable to the general description of the high voltage bushing arrangement given in the background section with reference to FIGS. 1 and 2 and reference will in the following be made to these figures. However, reference will first be made to FIG. 3, showing a schematic sectional view of a first embodiment of a corona shield according to the invention, wherein part of the hollow bushing insulator 2 and the upper outer terminal 8 are shown together with part of the corona shield 10. The corona shield is circularly cylindrical or toroid shaped like prior art corona shields and the left half thereof has been omitted in the figure for improved clarity.

The corona shield 10, which is electrically connected to the high voltage terminal by means of for example brackets and screws, comprises a thin shell shaped body portion, referenced 10a made of some suitable polymer material. The body is preferably made by means of a blow molding process. The cross-sectional shape of the body portion is essentially circular and the space 10b inside of the shell shaped body portion is left empty to be filled with air.

The outer surface of the body portion is at least partially provided with an electrically conductive layer 10c, shown with a dotted line in FIG. 3a. This electrically conductive layer is provided in order to achieve the required shielding. In the preferred embodiment shown in FIG. 3a, a radially inner portion 10d of the surface of the body 10a is free from an electrically conductive layer.

In a preferred embodiment shown in FIG. 3b, the inner portion 10d of the thin shell shaped body portion 10a is omitted.

The layer can be provided as an electrically conductive paint, preferably electrically conductive carbon paint. Alternatively, the paint is a conductive paint comprising silver, for example as silver glass particles. Silver is highly conductive and has excellent anti-corrosive parameters, which makes it ideal for this type of application.

In this embodiment the body portion 10a is made of an electrically non-conductive polymer since eddy currents induced in the body portion 10a are eliminated by making the internal body portion non-conductive, thereby avoiding heating losses due to such eddy currents.

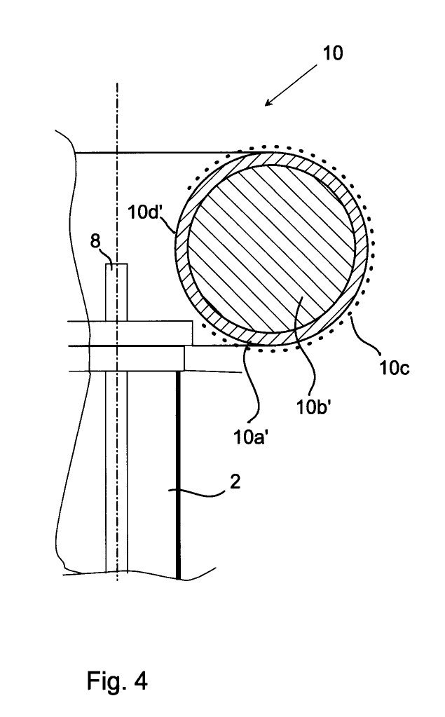

A second embodiment of a corona shield is shown in FIG. 4. This corona shield is in many aspects similar to the one of the first embodiment. Thus, it comprises a thin shell shaped body portion, referenced 10a′ made of some suitable polymer material. The outer surface of the body portion is at least partially provided with an electrically conductive layer 10c, shown with a dotted line in FIG. 4. However, the space 10b′ inside the body portion 10a′ is filled with some suitable low weight polymer material. This polymer material is preferably electrically non-conductive.

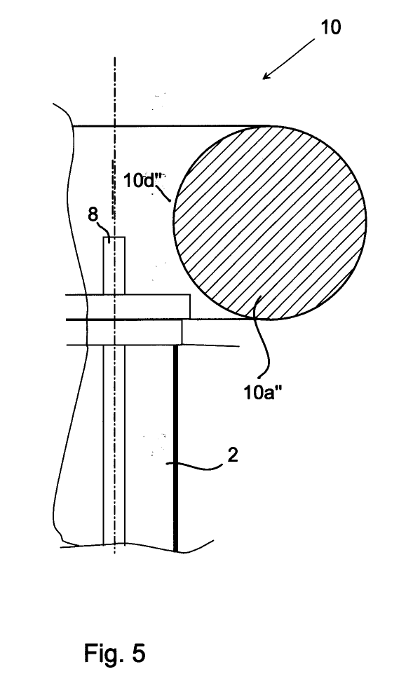

A third embodiment of a corona shield is shown in FIG. 5. This corona shield is in its general structure similar to the one of the first and second embodiments in that the body portion, referenced 10a″, is made of some suitable polymer material. However, this polymer material is electrically conductive, making any conductive layer on the surface thereof redundant. Yet an alternative design is to make the body portion 10b conductive; eddy current can be eliminated by removing section 10d″ or making this section non-conductive.

Preferred embodiments of a high voltage corona shield according to the invention and comprised in a bushing for a high voltage device has been described. A person skilled in the art realizes that this could be varied within the scope of the appended claims. Thus, the inventive corona shield is not limited to the configuration and geometrics shown in the figures.

Although the high voltage device has been described as a transformer, it will be appreciated that this device can be other apparatuses, such as a reactor, breaker, generator, or other device finding an application in high voltage systems. It is realized that the high voltage device also can be a wall of a building

1-7. (canceled)

8. A high voltage corona shield for minimizing corona appearing close to an outer terminal of a bushing included in a high voltage device, the corona shield comprising:
a toroid shaped body adapted to be arranged radially outside the outer terminal, wherein the body comprises a thin toroid shaped shell comprising a polymer material including a space inside and an electrically conductive layer provided on at least part of the surface of the shell, and wherein the conductive layer is electrically connected to the high voltage device.

9. The high voltage corona shield according to claim 8, wherein the polymer material is electrically non-conductive.

10. The high voltage corona shield according to claim 8, wherein a radially inner portion of a surface of the body is free from the electrically conductive layer.

11. The high voltage corona shield according to claim 8, wherein a radially inner portion of the surface of the body is omitted.

12. The high voltage corona shield according to claim 8, wherein the space inside the body is filled with air.

13. The high voltage corona shield according to claim 8, wherein the space inside the body is filled with a low weight, electrically non-conductive polymer material.

14. The high voltage corona shield according to claim 8, wherein the electrically conductive layer comprises an electrically conductive paint.

15. The high voltage corona shield according to claim 14, wherein the electrically conductive paint comprises carbon.

16. The high voltage corona shield according to claim 14, wherein the electrically conductive paint comprises silver.

17. A high voltage bushing, comprising:
a bushing insulator;
an outer terminal provided to electrically connect a high voltage device to an external source;
a corona shield arranged radially outside of the outer terminal, wherein the corona shield comprises:
a toroid shaped body comprising a thin toroid shaped shell comprising an electrically non-conductive polymer material with a space inside and an electrically conductive layer provided on at least part of the surface of the shell, wherein the conductive layer is electrically connected to the high voltage device.

18. The high voltage bushing according to claim 17, wherein the space inside the toroid shaped body is filled with air.

19. A high voltage bushing according to claim 17, wherein the space inside the toroid shaped body is filled with a low weight, electrically non-conductive polymer material.
